(19) United States
(12) Patent Application Publication
(10) Pub. No.: US 2004/0191467 A1
(43) Pub. Date: Sep. 30, 2004

(54) Soft material compensator

(76) Inventors: Gunther Merz, Neu-Isenburg (DE); Walther Merz, Darmstadt (DE)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/811,743

(22) Filed: Mar. 29, 2004

(30) Foreign Application Priority Data
Mar. 27, 2003 (DE) 10313918.4

(51) Int. Cl. B32B 33/00

(52) U.S. Cl. 428/85; 428/421

(57) ABSTRACT

A soft material compensator comprising a support carrier having at least one woven or knitted layer of fibers of natural or synthetic polymers, particularly mineral fibers, glass fibers, polyester fibers, polyamide fibers and/or aramid fibers, and comprising a barrier layer in the form of a polytetrafluoroethylene (PTFE) foil which is arranged at the side of the support carrier facing the inner side of the compensator and is bonded to the support carrier. For use in particular in the food or pharmaceutical industry, there is provided at the outer side of the compensator a protective layer in the form of an elastomeric outer layer that is likewise bonded to the support carrier, which protective layer significantly changes color in the event that a diffusion occurs from the interior of the compensator into the outer layer due to damages of the barrier layer.

### FIELD OF THE INVENTION

The invention relates to flexible piping connections and in particular to flexible piping connections comprising a compensator which is made of a soft material, said soft material compensator having a support carrier providing for stability and comprising at least one woven or knitted layer of fibers of natural or synthetic polymers, in particular mineral fibers, glass fibers, polyester fibers, polyamide fibers and/or aramid fibers, said soft material compensator further having a barrier layer in the form of a polytetrafluoroethylene (PTFE) film which is arranged at the side of the support carrier facing the inner side of the compensator and being bonded to the support carrier.

### DESCRIPTION OF THE RELATED ART

Soft material compensators of this lind are known from German Patents DE 44 10 414 C2 and DE 196 39 393 C2. Such soft material compensators are employed in piping systems for compensating variations in length that are caused by temperature differences, so as to connect piping elements in a tension free manner, to prevent the transmission of vibrations (for example, of pumps) and noises in the piping network, or for compensating extensions and lateral or longitudinal movements as well as vibrations between parts of the piping system. The materials used for soft material compensators have to fulfil in general, and in particular within the barrier layer, a unique combination of characteristics which in part contradict each other. Of particular importance are chemical and thermal stability in a in certain circumstances broad temperature range, superior diffusion and permeation stability when exposed to static or dynamic loads, particular high flexibility and good workability.

First of all, a soft material compensator has to prevent an escape into the environment of components of the substance fed within the piping system. When being used in the food or pharmaceutical industry it, however, may also be decisive to prevent to the highest possible extent penetration of substances which are detrimental to the product, in particular of health detrimental substances, from the environment of the piping system into the product passing through the soft material compensator, such as food or pharmaceuticals

### SUMMARY OF THE INVENTION

It is an object of the present invention to provide a soft material compensator which satisfactorily fulfils the above supplemental requirements.

Starting from a soft material compensator of the above-mentioned type, this object is solved by the invention in that for use in particular in the food or pharmaceutical industry there is provided at the outer side of the compensator a protecting layer in the form of an elastomeric outer layer which is likewise bonded to the support carrier, which protective layer significantly changes color in the event of diffusion from the interior of the compensator into the outer layer due to a damage of the barrier layer.

When the barrier layer which permanently is in contact with the product to be transported should become leaky for whatever reason this necessarily results in a diffusion from the product into the outer layer of the soft material compensator. This causes a change in color of the elastomeric outer layer. In this manner a malfunction of the soft material compensator immediately is made evident in a simple but reliable manner. The defective compensator thus can be immediately replaced.

A change in color of the outer layer of the soft material compensator is particularly well recognizable when the outer layer is composed of white silicon elastomer. Due to the striking white color it may be easily verified that compensators are installed, which for example are intended for use in the food or pharmaceutical production, and that not other compensators are installed due to an error or misuse.

Preferably the outer layer has sealing properties. In this manner it forms some kind of second skin of the compensator.

An elastomeric intermediate layer may be arranged between the support carrier and the barrier layer, wherein preferably the elastomeric intermediate layer and the barrier layer are chemically cross-linked. This provides for improved diffusion stability also for dynamic loads, combined with a higher flexibility of the compensator and a good workability, in a manner which is known per se from German Patent DE 44 10 413 C2.

The support carrier optionally may comprise at least two fiber layers between which an elastomeric intermediate layer is arranged for flexible mutual connection.

Preferably, also these intermediate layers may be composed of white silicon elastomer.

The individual layers of the compensator advantageously are bonded to each other by an adhesive or by heat sealing.

In dependency of the intended use of the soft material compensator, the barrier layer may be electrically non-conductive, or may be, as it is known from German Patent DE 196 39 393 C2 electrically conductive, and in particular may have a surface resistance of not more than 104 Ohm. The latter is of advantage particularly in cases where an explosive atmosphere may be generated in the region of the compensator so that it has to be guaranteed that electrostatic charges are removed from the compensator.

The coatings on the individual fibers of the support carrier preferably have a weight per unit area of at least 400 g/m2 or a thickness of at least 0.04 mm.

When using the soft material compensator in the food or pharmaceutical industry, all components of the compensator are selected such that they fulfil all requirements of the respective legal regulations, that is requirements as they are defined at present in particular in paragraph 21.177.2600 of the US-FDA-Regulations and the respective guidelines of the European community.

These and further objects, features and advantages of the present invention will become apparent from the following description when taken in connection with the accompanying drawings which, for purposes of illustration only, show several embodiments in accordance with present invention.

### Brief Description of the Drawings

FIG. 1 shows an enlarged schematic cross-section, not on scale, of the composite material used in the production of the soft material compensator of the invention, and

FIG. 2 shows a cross-section corresponding to FIG. 1 of a composite material of a further embodiment of a soft material compensator of the invention.

### Detailed Description of the Invention

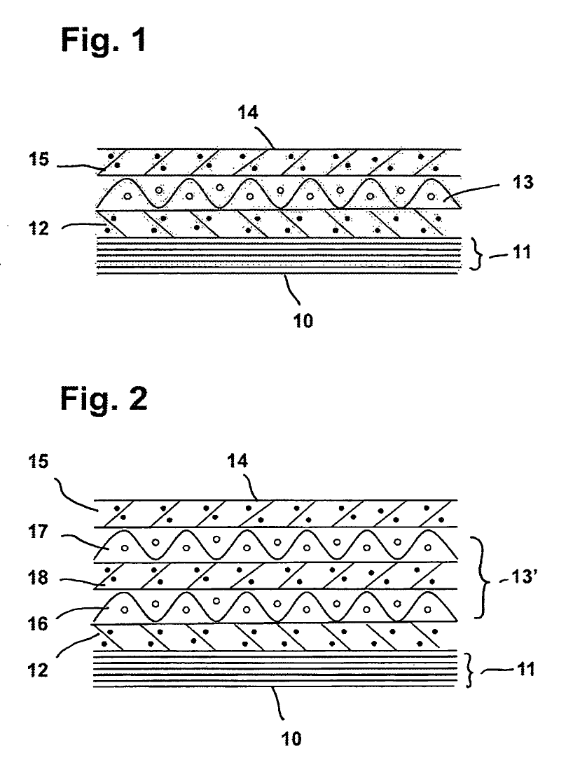

A soft material compensator which is made of a composite material as shown in FIG. 1 and which is intended for use in the food or pharmaceutical industry has at its inner side 10 a barrier or protective layer 11 which is made of a PTFE foil having a thickness of up to 25 μm. Such soft material compensators are used in the processing of products in solid or liquid form. Cleaning usually is done by means of gaseous media. The barrier layer 11 disposed at the inner side 10 of the soft material compensator thus comes into contact with materials in all states of aggregation and thus has to be resistant to all such materials.

In dependency on the respective requirements the barrier layer 11 may be made either electrically conductive or non-conductive. Advantageously an electrically non-conductive barrier layer 11 is composed of white PTFE foil so as to mark already during fabrication of the compensator the later intended use thereof in the food or pharmaceutical industry.

In particular in cases when at the site of use of the compensator there exists the risk of explosions, the barrier layer 11 preferably is made electrically conductive so as to provide for an electrically conductive connection between the parts of the piping system that usually are made of metal and within which the compensator is used. The individual piping parts of the piping system then need not to be grounded individually, and electrostatic charges may be discharged by the compensator itself in a secure manner. In such a case the barrier layer 11 preferably has a surface resistance of at most 104 Ohm.

The barrier layer 11 is bonded in a securely adhering but yet elastic manner to a support carrier 13 by means of an elastomeric intermediate layer 12. The intermediate layer 12 preferably is comprised of a white silicon rubber coating which is chemically cross-linked (vulcanized) with the PTFE-foil forming the barrier layer 11. The support carrier 13 is a woven or knitted fabric layer of fibers of natural or synthetic polymers, particularly of mineral fibers, glass fibers, polyester fibers, polyamide fibers and/or aramid fibers. Preferably the support carrier 13 is highly heat resistant, flame resistant and acid resistant. The support carrier 13 optionally may be made electrically conductive and can have a surface resistance of up to 104 Ohm.

On the outer side 14 of the compensator there is provided a protective layer in the form of an elastomeric outer layer 15 which likewise is connected to the support carrier 13. The outer layer 15 is designed such that it significantly changes color in the event that due to a damaging of the barrier layer 11 a diffusion from the interior of the compensator into the outer layer 15 occurs. Preferably the outer layer 15 consists of white silicon elastomer. The outer layer 15 constitutes a sealed outer skin of the compensator and it prevents on its own that health hazardous materials can penetrate from the environment of the compensator into the product fed through the compensator, even when the barrier layer has become defective. In case that a change in color of the outer layer 15 occurs, it can be recognized that there is a malfunction of the compensator. The defect compensator thus can be immediately replaced. Preferably the layered composition is designed such that the coatings on the individual threads of the support carrier 13, i.e. here layers 12 and 15, have weight per unit area of at least 400 g/m2 or have a layer thickness of at least 0.04 mm.

The composite described above can be composed, in the common manner, to soft material compensators of cylindrical, conical or any other shape, in particular by means of adhesive or heat sealing techniques.

For use in the food or pharmaceutical industry it is guaranteed by corresponding selection and processing of the materials, that all requirements of the pertinent legal regulations, such as paragraph 21.177.2600 of the U.S. FDA Regulations and the corresponding guidelines of the European Community, both with respect to the surfaces and to the edge portions of the compensator are fulfilled, for example, so as to avoid health risks for the users by carcinogenic substances. That means that the materials used and the soft material compensators made therefrom are to be examined for compliance with the corresponding legal regulations. For example, no deviations with respect to the requirements of the legal regulations mentioned above must occur during examination for global migrations of the migrants of the materials and composites used as well as in the course of a sensoric examination. To this end the prescribed formulas for the materials of the individual components and composites such as the support carrier, the elastomeric coatings and the foils for the barrier layers, always have to be fulfilled and documented. Similarly, the assembly of the materials to form the compensator has to comply with the legal regulations mentioned above.

The embodiment shown in FIG. 2 differs from that of FIG. 1 only in that a support carrier 13′ is provided which has two fiber layers 16 and 17 between which an elastomeric intermediate layer 18 is disposed. Intermediate layer 18 preferably likewise is composed of a white silicon elastomer.

While preferred embodiments in accordance with the present invention have been shown and described, it is understood that the invention is not limited thereto. These embodiments may be changed, modified and further applied by those skilled in the art. Therefore, this invention is not limited to the details shown and described previously but also includes all such changes and modifications which are encompassed by the appended claims.

We claim:

1. A soft material compensator comprising a support carrier having at least one layer of polymer fibers, and comprising a barrier layer in the form of a polytetrafluoroethylene (PTFE) foil which is arranged at the side of said support carrier facing the inner side of the compensator and is bonded to said support carrier, characterized in that there is provided at the outer side of the compensator a protective layer in the form of an elastomeric outer layer that is likewise bonded to said support carrier, which protective layer significantly changes color in the event that a diffusion occurs from the interior of the compensator into said outer layer due to damages of the barrier layer.

2. The soft material compensator as claimed in claim 1, wherein said layer of polymer fibers is a woven layer.

3. The soft material compensator as claimed in claim 1, wherein said layer of polymer fibers is a knitted layer.

4. The soft material compensator as claimed in claim 1, wherein said polymer fibers comprise natural polymer fibers.

5. The soft material compensator as claimed in claim 1, wherein said polymer fibers comprise synthetic polymer fibers selected from the group consisting of mineral fibers, glass fibers, polyester fibers, polyamide fibers and aramid fibers.

6. The soft material compensator as claimed in claim 1, wherein said outer layer consists of white silicon elastomer.

7. The soft material compensator as claimed in claim 1, wherein said outer layer has sealing properties.

8. The soft material compensator as claimed in claim 1, wherein at least one elastomeric intermediate layer is disposed between said support carrier and said barrier layer.

9. The soft material compensator as claimed in claim 8, wherein said elastomeric intermediate layer and said barrier layer are chemically cross-linked to each other.

10. The soft material compensator as claimed in claim 8, wherein said elastomeric intermediate layer is composed of white silicon elastomer.

11. The soft material compensator as claimed in claim 1, wherein said support carrier comprises at least two fiber layers between which an elastomeric intermediate layer is disposed.

12. The soft material compensator as claimed in claim 11, wherein said elastomeric intermediate layer is composed of white silicon elastomer.

13. The soft material compensator as claimed in claim 1, wherein the individual layers of the compensator are bonded to each other by an adhesive.

14. The soft material compensator as claimed in claim 1, wherein the individual layers of the compensator are bonded to each other by heat sealing.

15. The soft material compensator as claimed in claim 1, wherein said barrier layer is made electrically conductive.

16. The soft material compensator as claimed in claim 15, wherein said barrier layer has a surface resistance of at most 10⁴ Ohm.

17. The soft material compensator as claimed in claim 1, wherein the coatings on the individual fibers of the support carrier have a weight per unit area of at least 400 g/m².

18. The soft material compensator as claimed in claim 1, wherein the coatings on the individual fibers of the support carrier have a layer thickness of at least 0.04 mm.

19. The soft material compensator as claimed in claim 1, which is adapted for use in the food industry.

20. The soft material compensator as claimed in claim 19, wherein all parts of the compensator are selected such that they fulfill the requirements of the pertinent legal regulations.

21. The soft material compensator as claimed in claim 1, which is adapted for use in the pharmaceutical industry.

22. The soft material compensator as claimed in claim 21, wherein all parts of the compensator are selected such that they fulfill the requirements of the pertinent legal regulations.
